(19) United States
(12) Patent Application Publication
(10) Pub. No.: US 2018/0146703 A1
(43) Pub. Date: May 31, 2018

(54) NOVEL FLUORIDE PRENATAL DIETARY SUPPLEMENT

(71) Applicant: THE JOHNS HOPKINS UNIVERSITY, Baltimore, MD (US)

(72) Inventors: Irina Burd, Silver Spring, MD (US); Flavia Brancusi, Baltimore, MD (US); William Glenn, Vero Beach, FL (US)

(21) Appl. No.: 15/574,114

(22) PCT Filed: May 13, 2016
(86) PCT No.: PCT/US2016/032243

§ 371 Date: Nov. 14, 2017

Related U.S. Application Data
(60) Provisional application No. 62/162,198, filed on May 15, 2015.

(51) Int. Cl. A23L 33/165; A23L 33/00; A23L 33/15

(52) U.S. Cl. CPC A23L 33/165; A23V 2002/00; A23L 33/15; A23L 33/40

(57) ABSTRACT

The presently disclosed subject matter provides compositions, kits, and methods for administering a prenatal dietary supplement comprising at least about 3 mg of bioavailable fluoride to a pregnant woman.

### REFERENCE TO RELATED APPLICATIONS

This application claims the benefit of U.S. Provisional Patent Application No. 62/162,198 filed on May 15, 2015, which is hereby incorporated by reference for all purposes as if fully set forth herein.

### BACKGROUND OF THE INVENTION

Fluoride is an important nutrition supplement that may affect long term dentition in children (Leverett et al., Randomized clinical trial of the effect of prenatal fluoride supplements in preventing dental caries. Caries Research 1997, 31(3), 174-179). The Institute of Medicine has indicated the use of fluoride in pregnant women during the pre-eruptive development of the teeth to reduce dental caries (Dietary reference intakes for calcium, phosphorus, magnesium, vitamin D, and fluoride, Food and Nutrition Board, Institute of Medicine, 1997). Fluoride also has been previously associated with a reduction in preterm birth and increases in birth weight and length (neonatal ponderal index).

Currently, the existing prenatal dietary supplements on the market contain a low dose of fluoride, such as approximately 1 mg, or do not contain fluoride at all.

### SUMMARY OF THE INVENTION

In one aspect, the presently disclosed subject matter relates to a prenatal dietary supplement comprising a source of fluoride in an amount effective to provide at least about 3 mg of bioavailable fluoride. In some embodiments, the source of fluoride is in an amount effective to provide between about 3 mg and 5 mg of bioavailable fluoride. In some embodiments, the amount effective comprises between about 6 mg and 11 mg of the source of fluoride. In some embodiments, the amount effective comprises about 6.6 mg of the source of fluoride.

In some embodiments, the prenatal dietary supplement comprises decreased amounts of at least one cation that complexes with fluoride to reduce bioavailability of fluoride. In some embodiments, at least one cation is selected from the group consisting of calcium and magnesium. In some embodiments, the prenatal dietary supplement comprises a source of calcium that does not complex with fluoride to reduce the bioavailability of fluoride. In some embodiments, the source of calcium comprises calcium complexed to a vitamin. In some embodiments, the source of calcium comprises calcium complexed to vitamin B5. In some embodiments, the prenatal dietary supplement comprises about 10 mg of vitamin B5 and about 0.84 mg calcium as a complex.

In some embodiments, the source of fluoride is selected from the group consisting of sodium fluoride, sodium monofluorophosphate, stannous fluoride, and combinations thereof. In some embodiments, the source of fluoride comprises sodium fluoride.

In some embodiments, the prenatal dietary supplement further comprises between about 0 mg and about 2000 mg of vitamin C. In some embodiments, the prenatal dietary supplement further comprises about 200 mg of vitamin C. In some embodiments, the prenatal dietary supplement further comprises between about 0 mg and 100 mg of vitamin B₁. In some embodiments, the prenatal dietary supplement further comprises about 10 mg of vitamin B₁. In some embodiments, the prenatal dietary supplement further comprises between about 0 mg and 60 mg of vitamin B₂. In some embodiments, the prenatal dietary supplement further comprises about 6 mg of vitamin B₂. In some embodiments, the prenatal dietary supplement further comprises between about 0 mg and 35 mg of vitamin B₃. In some embodiments, the prenatal dietary supplement further comprises about 30 mg of vitamin B₃. In some embodiments, the prenatal dietary supplement further comprises between about 0 mg and 50 mg of vitamin B₆. In some embodiments, the prenatal dietary supplement further comprises about 5 mg of vitamin B₆. In some embodiments, the prenatal dietary supplement further comprises between about 0 mg and 1 mg of folic acid. In some embodiments, the prenatal dietary supplement further comprises about 1 mg of folic acid. In some embodiments, the prenatal dietary supplement further comprises between about 0 μg and 150 μg of vitamin B₁₂. In some embodiments, the prenatal dietary supplement further comprises about 15 μg of vitamin B₁₂. In some embodiments, the prenatal dietary supplement further comprises between about 0 mg and 100 mg of vitamin B₅. In some embodiments, the prenatal dietary supplement further comprises about 10 mg of vitamin B₅. In some embodiments, the prenatal dietary supplement further comprises between about 0 mg and 69 mg of magnesium sulfate. In some embodiments, the prenatal dietary supplement further comprises about 6.9 mg of magnesium sulfate. In some embodiments, the prenatal dietary supplement further comprises between about 0 mg and 40 mg of zinc. In some embodiments, the prenatal dietary supplement further comprises about 18.2 mg of zinc. In some embodiments, the prenatal dietary supplement further comprises between about 0 mg and 10 mg of copper. In some embodiments, the prenatal dietary supplement further comprises about 0.8 mg of copper. In some embodiments, the prenatal dietary supplement further comprises between about 0 mg and 13 mg of manganese sulfate. In some embodiments, the prenatal dietary supplement further comprising about 1.3 mg of manganese sulfate.

In some embodiments, the prenatal dietary supplement extends the length of gestation of a fetus when the supplement is administered to a pregnant woman during the second and third trimesters of pregnancy. In some embodiments, the prenatal dietary supplement changes the natural microbiome of a pregnant woman when administered to a pregnant woman during the second and third trimesters of pregnancy. In some embodiments, the supplement protects a pregnant woman and her fetus against transient bacteremia and ascending infection when the supplement is administered to the pregnant woman during the second and third trimesters of pregnancy.

In some embodiments, the prenatal dietary supplement is formulated for administration on an empty stomach or after drinking water. In some embodiments, the prenatal dietary supplement is formulated for administration at least 3 or at least 4 hours before, or at least 1 hour after, consumption of a food, beverage, or other supplement comprising calcium. In some embodiments, the supplement is formulated for administration at night. In some embodiments, the supplement is formulated for administration once during a 24 hour period. In some embodiments, the supplement is formulated for administration during the second and/or third trimester of pregnancy. In some embodiments, the prenatal dietary supplement comprises a form selected from the group consisting of a pill, tablet, capsule, liquid, liquid concentrate, and powder.

In other aspects, the presently disclosed subject matter provides a kit comprising: (a) a prenatal dietary supplement according to any one of claims 1-45; and (b) a package insert or label with directions to administer the prenatal dietary supplement to a pregnant woman during the second and/or third trimesters of her pregnancy. In some embodiments, the directions instruct the pregnant woman to take the prenatal dietary supplement on an empty stomach. In some embodiments, the directions instruct the pregnant woman to take the prenatal dietary supplement at night.

In some aspects, the presently disclosed subject matter provides a method for increasing the length of gestation of a fetus, the method comprising administering the presently disclosed prenatal dietary supplement, or presently disclosed kit, to the pregnant woman.

In certain aspects, the presently disclosed subject matter provides a method for changing the natural microbiome of a pregnant woman, the method comprising administering the presently disclosed prenatal dietary supplement, or presently disclosed kit, to the pregnant woman. In some embodiments, the natural microbiome comprises a microbiome of the oral cavity, genital tract, and/or gastrointestinal tract of the pregnant woman.

In other aspects, the presently disclosed subject matter provides a method for protecting a pregnant woman and her fetus against transient bacteremia and/or ascending infection, the method comprising administering the presently disclosed prenatal dietary supplement, or presently disclosed kit, to the pregnant woman. In some embodiments, the prenatal dietary supplement is administered when the pregnant woman has an empty stomach or has previously ingested water. In some embodiments, the prenatal dietary supplement is administered at least 3 or at least 4 hours before, or at least 1 hour after, the pregnant woman consumes a food, beverage, or other supplement comprising calcium. In some embodiments, the pregnant woman is instructed not to drink milk or consume any other food, beverage, or other supplement comprising calcium at least 3 or at least 4 hours before taking, or at least 1 hour after taking, the prenatal dietary supplement. In some embodiments, the prenatal dietary supplement is administered with plenty of water. In some embodiments, the prenatal dietary supplement is administered at night. In some embodiments, the prenatal dietary supplement is administered once every 24 hours. In some embodiments, the prenatal dietary supplement is administered during the second and/or third trimester of pregnancy. In some embodiments, the prenatal dietary supplement is administered from the 12th week of pregnancy until the pregnant woman gives birth.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### DETAILED DESCRIPTION OF THE INVENTION

The presently disclosed subject matter now will be described more fully hereinafter. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims.

The presently disclosed subject matter provides compositions, kits, and methods for administering a prenatal dietary supplement comprising fluoride to a pregnant woman. It is disclosed herein that adequate intake of fluoride in a pregnant woman changes the natural microbiome of the pregnant woman, such as in her oral cavity, genital tract, and/or gastrointestinal tract. This change in the natural microbiome protects a pregnant woman against transient bacteremia and protects her fetus against ascending infection, thereby decreasing the chances of adverse perinatal outcomes.

Prenatal Dietary Supplement Compositions

The presently disclosed prenatal dietary supplement, and specifically the fluoride in the supplement, has a beneficial effect on the natural microbiome of the maternal oral cavity, genital tract, and/or gastrointestinal tract, thereby protecting the mother against transient bacteremia and the fetus against ascending infection. This protection is believed to reduce adverse perinatal outcomes, such as prematurity and preterm premature rupture of membranes. The terms “premature birth” and “prematurity” generally refers to the birth of a baby at less than about 37 weeks of gestational age. In some embodiments, the presently disclosed prenatal dietary supplement is believed to extend the length of gestation of a fetus. In some embodiments, the length of gestation increases by at least about 5%, 10%, 15%, 20%, 25%, 30%, or 40% as compared to the length of gestation of a fetus whose mother was not administered the presently disclosed prenatal dietary supplement using the presently disclosed methods. In some embodiments, the length of gestation is increased from about 28 weeks to about 35 weeks.

A “prenatal dietary supplement” as used herein refers to a supplement given to a pregnant woman to promote her health and the health of her fetus during her pregnancy. A prenatal dietary supplement is also generally referred to as a “prenatal vitamin”. In some embodiments, the prenatal dietary supplement comprises a source of fluoride in an amount effective to provide about 3 mg of bioavailable fluoride. In some embodiments, the source of fluoride is in an amount effective to provide between about 3 mg and 5 mg of bioavailable fluoride. In some embodiments, the source of fluoride comprises between about 6 mg and 11 mg. In some embodiments, the source of fluoride comprises about 6.6 mg.

The source of fluoride found in the prenatal dietary supplement is in a form that can be made bioavailable, such as sodium fluoride (NaF), sodium monofluorophosphate (Na₂PO₃F), and stannous fluoride (SnF₂). The term “bioavailable” as used herein refers to the dose of a compound that reaches systemic circulation after being administered. In some embodiments, the fluoride is in the form of sodium fluoride. In some embodiments, the fluoride is in the form of sodium monofluorophosphate. In some embodiments, the fluoride is in the form of stannous fluoride. In some embodiments, the source of fluoride is selected from the group consisting of sodium fluoride, sodium monofluorophosphate, stannous fluoride, and combinations thereof. In some embodiments, the fluoride is not in the form of calcium fluoride, which has been found to be generally not bioavailable.

The prenatal dietary supplement of the presently disclosed subject matter is formulated to have decreased amounts of cations with which fluoride may complex to form insoluble compounds that limit fluoride absorbability and bioavailability. As used herein, the term “cation” refers to positively-charged ions such as calcium (Ca²⁺), magnesium (Mg²⁺), potassium (K⁺), sodium (Na⁺) hydrogen (H⁺), aluminum (Al³⁺), iron (Fe²⁺), manganese (Mn²⁺), zinc (Zn²⁺) and copper (Cu²⁺). As used herein, “decreased amounts” means that the supplement may contain an amount of cations that is negligible and would not be expected to significantly impact fluoride absorption. In some embodiments, “decreased amounts” means that the supplement contains an amount of cations that is less than 0.01%, 1.0%, 10%, 20%, 30%, 40%, 50%, 60%, 70%, or 80% of a commercially available supplement. In some embodiments, “decreased amounts” means that the supplement contains an amount of the cation that reduces fluoride absorption by less than 1%. In some embodiments, “As used herein, “poorly absorbed compounds” are those compounds which are not generally bioavailable. In some embodiments, the supplement comprises decreased amounts of at least one cation that complexes with fluoride to reduce bioavailability of fluoride. In some embodiments, at least one cation is selected from the group consisting of calcium and magnesium. In some embodiments, the supplement has decreased amounts of calcium ions. In some embodiments, the supplement contains an amount of calcium cations that is less than about 0.01%, 0.05%, 0.10%, 0.25%, 0.30%, 0.33%, 0.40%, 0.50%, 0.66%, 0.75%, 0.80%, 0.90% or 1.0% of the total weight the prenatal dietary supplement of the presently disclosed subject matter. In some embodiments, the supplement has decreased amounts of magnesium ions. In some embodiments, the supplement contains an amount of magnesium cations that is less than 0.01%, 0.05%, 0.10%, 0.25%, 0.30%, 0.33%, 0.40%, 0.50%, 0.66%, 0.75%, 0.80%, 0.90% or 1.0% of the total weight the prenatal dietary supplement of the presently disclosed subject matter.

In some embodiments, the supplement comprises a source of calcium that is in a form that does not complex with or bind to fluoride. For example, the source of calcium may be bound to or complexed with a vitamin, such as vitamin B₅. In this case, the calcium in the vitamin B₅-calcium complex does not bind to fluoride, thereby allowing the fluoride to still be bioavailable.

It should be appreciated that the prenatal dietary supplement of the presently disclosed subject matter can optionally include a variety of vitamins and minerals which would be beneficial to the overall health and well being of a pregnant woman and her developing fetus. In some embodiments, the supplement comprises vitamin C (also termed ascorbate and 2-oxo-L-threo-hexono-1,4-lactone-2,3-enediol). In some embodiments, the supplement comprises between about 0 mg and about 2000 mg of vitamin C. In some embodiments, the supplement comprises about 200 mg of vitamin C.

In some embodiments, the supplement comprises vitamin B₁ (also termed thiamine and 3-((4-Amino-2-methyl-5-pyrimidinyl)methyl)-5-(2-hydroxyethyl)-4-methylthiazolium chloride). In some embodiments, the supplement comprises between about 0 mg and 100 mg of vitamin B₁. In some embodiments, the supplement comprises between about 0 mg and about 30 mg of vitamin B₁. In some embodiments, the supplement comprises about 10 mg of vitamin B₁.

In some embodiments, the supplement comprises vitamin B₂ (also termed riboflavin and 7,8-dimethyl-10-[(2S,3S,4R)-2,3,4,5-tetrahydroxypentyl]benzo [g]pteridine-2,4-dione). In some embodiments, the supplement comprises between about 0 mg and 60 mg of vitamin B₂. In some embodiments, the supplement comprises between about 0 mg and 35 mg of vitamin B₂. In some embodiments, the supplement comprises about 6 mg of vitamin B₂.

In some embodiments, the supplement comprises vitamin B₃ (also termed niacin and pyridine-3-carboxylic acid). In some embodiments, the supplement comprises between about 0 mg and 40 mg of vitamin B₃. In some embodiments, the supplement comprises about 30 mg of vitamin B₃.

In some embodiments, the supplement comprises vitamin B₆ (for e.g., pyridoxine hydrochloride, pyridoxal 5′-phosphate). In some embodiments, the supplement comprises between about 0 mg and 100 mg of vitamin B₆. In some embodiments, the supplement comprises between about 0 mg and 20 mg of vitamin B₆. In some embodiments, the supplement comprises about 5 mg of vitamin B₆.

In some embodiments, the supplement comprises folic acid (also termed folate, vitamin B₉, and 2S)-2-[[4-[(2-amino-4-oxo-1H-pteridin-6-yl)methylamino]benzoyl]amino] pentanedioic acid). In some embodiments, the supplement comprises between about 0 mg and 1 mg of folic acid. In some embodiments, the supplement comprises 0.1 mg of folic acid. In some embodiments, the supplement comprises 0.2 mg of folic acid. In some embodiments, the supplement comprises 0.25 mg of folic acid. In some embodiments, the supplement comprises 0.3 mg of folic acid. In some embodiments, the supplement comprises 0.4 mg of folic acid. In some embodiments, the supplement comprises 0.5 mg of folic acid. In some embodiments, the supplement comprises 0.6 mg of folic acid. In some embodiments, the supplement comprises 0.7 mg of folic acid. In some embodiments, the supplement comprises 0.8 mg of folic acid. In some embodiments, the supplement comprises 0.9 mg of folic acid. In some embodiments, the supplement comprises about 1 mg of folic acid.

In some embodiments, the supplement comprises vitamin B₁₂ (also termed cobalamin and α-(5,6-dimethylbenzimidazolyl)cobamidcyanide). In some embodiments, the supplement comprises between about 0 μg and 150 μg of vitamin B₁₂. In some embodiments, the supplement comprises between about 0 μg and 100 μg of vitamin B₁₂. In some embodiments, the supplement comprises 10 μg of vitamin B₁₂. In some embodiments, the supplement comprises 11 μg of vitamin B₁₂. In some embodiments, the supplement comprises 12 μg of vitamin B₁₂. In some embodiments, the supplement comprises 13 μg of vitamin B₁₂. In some embodiments, the supplement comprises 14 μg of vitamin B₁₂. In some embodiments, the supplement comprises about 15 μg of vitamin B₁₂. In some embodiments, the supplement comprises 16 μg of vitamin B₁₂. In some embodiments, the supplement comprises 17 μg of vitamin B₁₂. In some embodiments, the supplement comprises 18 μg of vitamin B₁₂. In some embodiments, the supplement comprises 19 μg of vitamin B₁₂. In some embodiments, the supplement comprises 20 μg of vitamin B₁₂.

In some embodiments, the supplement comprises vitamin B₅ (also termed pantothenic acid and 3-[(2R)-2,4-dihydroxy-3,3-dimethylbutanamido]propanoic acid). In some embodiments, the supplement comprises between about 0 mg and 100 mg of vitamin B₅. In some embodiments, the supplement comprises about 10 mg of vitamin B₅. In some embodiments, the supplement comprises about 5 mg, about 6 mg, about 7 mg, about 8 mg, about 9 mg, about 10 mg, about 11 mg, about 12 mg, about 13 mg, about 14 mg, or about 15 mg of Vitamin B₅. In some embodiments, the supplement comprises about 5 mg, about 6 mg, about 7 mg, about 8 mg, about 9 mg, about 10 mg, about 11 mg, about 12 mg, about 13 mg, about 14 mg, or about 15 mg of Vitamin B₅ and about 0.70 mg, about 0.71 mg, about 0.72 mg, about 0.73 mg, about 0.74 mg, about 0.75 mg, about 0.76 mg, about 0.77 mg, about 0.78 mg, about 0.79 mg, about 0.80 mg, about 0.81 mg, about 0.82 mg, about 0.83 mg, about 0.84 mg, about 0.85 mg, about 0.86 mg, about 0.87 mg, about 0.88 mg, about 0.89 mg, about 0.90 mg, about 0.91 mg, about 0.92 mg, about 0.93 mg, about 0.94 mg or about 0.95 mg calcium as a complex. In some embodiments, the supplement comprises about 10 mg of vitamin B₅ and about 0.84 mg calcium as a complex.

In some embodiments, the supplement comprises magnesium sulfate (MgSO₄). In some embodiments, the supplement comprises between about 0 mg and 350 mg of magnesium sulfate. In some embodiments, the supplement comprises about 6.0 mg, about 6.1 mg, about 6.2 mg, about 6.3 mg, about 6.4 mg about 6.5 mg, about 6.6 mg, about 6.7 mg, about 6.8 mg, about 6.9 mg, about 7.0 mg, about 7.1 mg, about 7.2 mg, about 7.3 mg, about 7.4 mg about 7.5 mg, about 7.6 mg, about 7.7 mg, about 7.8 mg, about 7.9 mg, or about 8.0 mg of magnesium sulfate. In some embodiments, the supplement comprises about 6.9 mg of magnesium sulfate.

In some embodiments, the supplement comprises zinc, such as zinc sulfate. In some embodiments, the supplement comprises between about 0 mg and 40 mg of zinc. In some embodiments, the supplement comprises between about 0 mg and 25 mg of zinc. In some embodiments, the supplement comprises about 17.0 mg, about 17.1 mg, about 17.2 mg, about 17.3 mg, about 17.4 mg about 17.5 mg, about 17.6 mg, about 17.7 mg, about 17.8 mg, about 17.9 mg, about 18.0 mg, about 18.1 mg, about 18.2 mg, about 18.3 mg, about 18.4 mg about 18.5 mg, about 18.6 mg, about 18.7 mg, about 18.8 mg, about 18.9 mg, or about 19.0 mg of zinc. In some embodiments, the supplement comprises about 18.2 mg of zinc.

In some embodiments, the supplement comprises copper, such as cupric sulfate. In some embodiments, the supplement comprises between about 0 mg and 10 mg of copper.

In some embodiments, the supplement comprises between about 0 mg and 2 mg of copper. In some embodiments, the supplement comprises about 0.1 mg, about 0.2 mg, about 0.3 mg, about 10.4 mg about 0.5 mg, about 0.6 mg, about 0.7 mg, about 0.8 mg, about 0.9 mg, about 1.0 mg, about 1.1 mg, about 1.2 mg, about 1.3 mg, about 1.4 mg about 1.5 mg, about 1.6 mg, about 1.7 mg, about 1.8 mg, or about 1.9 mg of copper. In some embodiments, the supplement comprises about 0.8 mg of copper.

In some embodiments, the supplement comprises manganese sulfate (MnSO₄(H₂O). In some embodiments, the supplement comprises between about 0 mg and 11 mg of manganese sulfate. In some embodiments, the supplement comprises between about 0 mg and 5 mg of manganese sulfate. In some embodiments, the supplement comprises about 0.1 mg, about 0.2 mg, about 0.3 mg, about 10.4 mg about 0.5 mg, about 0.6 mg, about 0.7 mg, about 0.8 mg, about 0.9 mg, about 1.0 mg, about 1.1 mg, about 1.2 mg, about 1.3 mg, about 1.4 mg about 1.5 mg, about 1.6 mg, about 1.7 mg, about 1.8 mg, about 1.9 mg, or about 2.0 mg of manganese sulfate. In some embodiments, the supplement comprises about 1.3 mg of manganese sulfate.

In some embodiments, other optional ingredients can be added to the prenatal dietary supplement of the presently disclosed subject matter. These include, but are not limited to carotenoids, such as lutein, α-carotene, β-carotene, zeaxanthin, and cryptoxanthin; polyphenols, such as tannins, lignins, and flavonoids; other vitamins; other minerals; amino acids; fruit extracts; vegetable extracts; preservatives; sweeteners; flavorings, and colorants. Other examples of optional ingredients include, but are not limited to, vitamin A (e.g., between about 4000 IU and 8150 IU and/or between about 77 μg and 3 mg), vitamin D3 (e.g., between about 400 IU and 1000 IU), vitamin E (e.g., between about 30 μg and 150 mg), vitamin K (1 and 2; e.g., between about 11 IU and 200 IU and/or between about 9 μg and 900 μg), iron (e.g., between about 18 μg and 50 μg), iodine (e.g., kelp; e.g., between about 50 μg and 150 μg), selenium (e.g., between about 35 μg and 200 μg), chromium (e.g., between about 30 μg and 200 μg), molybdenum (e.g., between about 25 μg and 100 μg), biotin (e.g., between about 3 μg and 30 μg), potassium (e.g., between about 6 mg and 10 mg), choline (e.g., from soy lecithin; e.g., between about 45 μg and 3.5 mg), inositol (e.g., between about 10 mg and 75 mg), omega-3 fatty acids (e.g., between about 65 and 500 mg), omega-5 fatty acids (e.g., between about 0.1 mg and 10 mg), omega-6 fatty acids (e.g., between about 14 mg and 1400 mg), omega-7 fatty acids (e.g., between about 10 mg and 1000 mg), omega-9 fatty acids (e.g., between about 66 mg and 6600 mg), PABA (para amino benzoic acid; e.g., between about 6.9 mg and 690 mg), rutin (e.g., between about 0.5 mg and 50 mg), sunflower lecithin (e.g., soy free; e.g., between about 15 mg and 1500 mg), boron (e.g., between about 50 mg and 5000 mg), and spirulina (e.g., organic; e.g. between about 30 mg and 3000 mg). The prenatal dietary supplement of the presently disclosed subject matter is formulated to maximize bioavailability of fluoride. In some embodiments, the supplement is formulated for administration on an empty stomach. In some embodiments, the supplement is formulated for administration to a subject that has previously ingested a liquid, such as water. In some embodiments, the supplement is formulated for administration after the subject drinks up to about 4 cups of water prior to taking the supplement. In some embodiments, the supplement is formulated for administration along with about 0.5 cups (4 ounces) of water. In some embodiments, the supplement is formulated for administration along with about 5 ounces of water. In some embodiments, the supplement is formulated for administration along with about 6 ounces of water. In some embodiments, the supplement is formulated for administration along with about 7 ounces of water. In some embodiments, the supplement is formulated for administration along with about 8 ounces of water. In some embodiments, the supplement is formulated for administration along with about 10 ounces, about 12 ounces, about 14 ounces, about 16 ounces, about 20 ounces, about 24 ounces, or more of water. In some embodiments, the supplement is formulated for administration at least 3 or at least 4 hours before consumption of a food, beverage, or other supplement comprising calcium. In some embodiments, the supplement is formulated for administration at least 1 hour after consumption of a food, beverage, or other supplement comprising calcium. In some embodiments, the supplement is formulated for administration at least approximately 6 hours before or after consumption of a food, beverage, or other supplement comprising calcium. In some embodiments, the supplement is formulated for administration at night. In some embodiments, the supplement is formulated for administration once during a 24 hour period. In some embodiments, the supplement is formulated for administration during the second and/or third trimester of pregnancy.

As used herein, the term “microbiome” refers to the totality of microbes, such as bacteria, fungi, and protists, and their genetic elements or genomes in a defined environment, e.g. within the oral cavity, genital tract, and/or gastrointestinal tract of a host. As used herein, the term “natural microbiome” refers to the microbiome of a subject before administration of a presently disclosed supplement. “Natural microbiome” may also refer to the microbiome of a subject that is not given a presently disclosed supplement. Microbiomes can be investigated or monitored using rapid DNA sequencing techniques, such as by sequencing 16S rRNA. In some embodiments, in order to sequence microbiome DNA (target DNA), it is desirable to remove contaminating mammalian genomic DNA (non-target DNA) from a DNA mixture obtained from a biological sample.

In some embodiments, the biological sample may be taken from saliva, mucosa, blood, tissue, stool, urine, oral rinses, and oral swabs, for example. In some embodiments, the relative distribution of taxonomic groups based on 16S rRNA sequence data is used to identify and characterize the microbial flora associated with the human body. In some embodiments, the microbiome may be monitored by identifying bacterial taxa, bacterial metabolic products, and/or proteins in a biological sample. In some embodiments, the microbiome is monitored by an analysis of amplification products of DNA and/or RNA of microflora, e.g. based on an analysis of amplification products of genes coding for one or more of: small subunit rRNA, intervening transcribed spacer, and large subunit rRNA. In some embodiments, the microbiome is monitored by assaying the mRNA composition of a biological sample.

In some embodiments, the distribution of microbial families within the microbiome is determined. In some embodiments, characterization may be carried to more detailed levels, e.g. to the level of genus and/or species, and/or to the level of strain or variation (e.g. variants) within a species, if desired (including the presence or absence of various genetic elements such as genes, the presence or absence of plasmids, etc.). Alternatively, higher taxanomic designations can be used such as Phyla, Class, or Order. The objective is to identify which microbes (usually bacteria, but also optionally fungi, such as yeasts, protists, etc.) are present in the sample from the individual and the relative distributions of those microbes, e.g. expressed as a percentage of the total number of microbes that are present, thereby establishing a microfloral pattern or signature for the subject being tested, e.g. for the region of the oral cavity, genital tract, and/or gastrointestinal tract that has been sampled, or for the type of sample that is analyzed.

In some embodiments, when many taxa are being considered, the overall pattern of microflora is assessed, i.e. not only are particular taxa identified, but the percentage of each constituent taxon is taken in account, in comparison to all taxa that are detected and, usually, or optionally, to each other. Those of skill in the art will recognize that many possible ways of expressing or compiling such data exist. For example, a “pie chart” format may be used to depict a microfloral signature; or the relationships may be expressed numerically or graphically as ratios or percentages of all taxa detected, etc. Further, the data may be manipulated so that only selected subsets of the taxa are considered (e.g. key indicators with strong positive correlations). Data may be expressed, e.g. as a percentage of the total number of microbes detected, or as a weight percentage, etc. In some embodiments, a nonparametric multivariate test such as Metastats, Analysis of Similarity, Principle Component Analysis, Non-Parametric MANOVA (Kruskal-Wallace) etc. can be used to associate a change in microbiome from a subject before the prenatal dietary supplement is administered to the microbiome of the subject after the prenatal dietary supplement has been administered.

In some embodiments, there are changes in the microbiota composition. In some embodiments, there are changes in the total number of bacteria in the microbiome. In some embodiments, there are changes in both the microbiota composition and the total number of bacteria in the microbiome. In some embodiments, there are changes in the total number of at least one type of anaerobic bacteria. In some embodiments, there are changes in the total number of at least one type of anaerobic, gram-negative bacteria. In some embodiments, there are changes in the total number of at least one type of bacteria selected from the group consisting of anaerobic gram-negative bacteria, such as Porphyromonas gingivalis, Campylobacter rectus, Tannerella forsythensis, Treponema denticola, Fusobacterium nucleatum, Peptostreptococcus micros, Prevotella intermedia, and Prevotella nigrescence. In some embodiments, there are changes in the total number of Porphyromonas gingivalis. In some embodiments, there are changes in the total number of Campylobacter rectus. In some embodiments, there are changes in the total number of Tannerella forsythensis. In some embodiments, there are changes in the total number of Treponema denticola. In some embodiments, there are changes in the total number of Fusobacterium nucleatum. In some embodiments, there are changes in the total number of Peptostreptococcus micros. In some embodiments, there are changes in the total number of Prevotella intermedia. In some embodiments, there are changes in the total number of Prevotella nigrescence. As used herein, the term “anaerobic bacteria” refers to bacteria that do not require normal levels of oxygen for survival and/or growth. As used herein, the term “gram-negative bacteria” refer to those classes of bacteria that do not retain the crystal violet stain. As used herein, the term “bacteremia” refers to the presence of bacteria in the blood. “Transient bacteremia” refers to bacteremia that is not persistent. Bacteremia in a pregnant woman can affect the woman as well as the fetus. As used herein, an “ascending infection” is an infection in which the organism causing the infection contaminates the amniotic fluid.

One of skill in the art will recognize that agents for use within the compositions, kits and methods of the presently disclosed subject matter include the pharmaceutically acceptable salts of the compounds described above. The term “pharmaceutically acceptable salts” is meant to include salts of active compounds, which are prepared with relatively nontoxic acids or bases, depending on the particular substituent moieties found on the compounds described herein.

Certain agents for use within the methods of the presently disclosed subject matter can exist in unsolvated forms, as well as solvated forms, including hydrated forms. In general, the solvated forms are equivalent to unsolvated forms and are encompassed within the scope of the present disclosure. Certain agents for use within the methods of the presently disclosed subject matter may exist in multiple crystalline or amorphous forms.

The presently disclosed prenatal dietary supplement can be administered using a variety of methods known in the art. The administering can be carried out by, for example, intravenous infusion; injection by intravenous, intraperitoneal, intracerebral, intramuscular, intraocular, intraarterial or intralesional routes; or topical or oral application. In some particular embodiments, as described herein, the presently disclosed supplements are administered orally.

In some embodiments, the prenatal dietary supplement is in the form of a tablet. In some embodiments, the prenatal dietary supplement is in the form of a pill. In some embodiments, the prenatal dietary supplement is in the form of a capsule. In some embodiments, the prenatal dietary supplement is in the form of a liquid or liquid concentrate. In some embodiments, the prenatal dietary supplement is in the form of a powder.

Agents for use within the compositions, kits, and methods of the presently disclosed subject matter can be manufactured in a manner known in the art, e.g. by means of conventional mixing, dissolving, granulating, dragee-making, levitating, emulsifying, encapsulating, entrapping or lyophilizing processes.

More particularly, agents within the compositions, kits, and methods of the presently disclosed subject matter for oral use can be obtained through combination of active compounds with a solid excipient, optionally grinding a resulting mixture, and processing the mixture of granules, after adding suitable auxiliaries, if desired, to obtain tablets or dragee cores. Suitable excipients include, but are not limited to, carbohydrate or protein fillers, such as sugars, including lactose, sucrose, mannitol, or sorbitol; starch from corn, wheat, rice, potato, or other plants; cellulose, such as methyl cellulose, hydroxypropylmethyl-cellulose, or sodium carboxymethyl cellulose; and gums including arabic and tragacanth; and proteins, such as gelatin and collagen; and polyvinylpyrrolidone (PVP:povidone). If desired, disintegrating or solubilizing agents, such as cross-linked polyvinyl pyrrolidone, agar, alginic acid, or a salt thereof, such as sodium alginate, also can be added to the compositions.

Dragee cores are provided with suitable coatings, such as concentrated sugar solutions, which also can contain gum arabic, talc, polyvinylpyrrolidone, carbopol gel, polyethylene glycol (PEG), and/or titanium dioxide, lacquer solutions, and suitable organic solvents or solvent mixtures. Dyestuffs or pigments can be added to the tablets or dragee coatings for product identification or to characterize the quantity of active compound, e.g., dosage, or different combinations of active compound doses.

Pharmaceutical compositions suitable for oral administration include push-fit capsules made of gelatin, as well as soft, sealed capsules made of gelatin and a coating, e.g., a plasticizer, such as glycerol or sorbitol. The push-fit capsules can contain active ingredients admixed with a filler or binder, such as lactose or starches, lubricants, such as talc or magnesium stearate, and, optionally, stabilizers. In soft capsules, the active compounds can be dissolved or suspended in suitable liquids, such as fatty oils, liquid paraffin, or liquid polyethylene glycols (PEGs), with or without stabilizers. Stabilizers can be added as warranted.

In some embodiments, the agents for use within the compositions, kits, and methods of the presently disclosed subject matter can be administered by rechargeable or biodegradable devices. For example, a variety of slow-release polymeric devices have been developed and tested in vivo for the controlled delivery of drugs, including proteinacious biopharmaceuticals. Suitable examples of sustained release preparations include semipermeable polymer matrices in the form of shaped articles, e.g., films or microcapsules. Sustained release matrices include polyesters, hydrogels, polylactides (U.S. Pat. No. 3,773,919; EP 58,481), copolymers of L-glutamic acid and gamma ethyl-L-glutamate (Sidman et al., Biopolymers 22:547, 1983), poly (2-hydroxyethyl-methacrylate) (Langer et al., J. Biomed. Mater. Res. 15:167, 1981; Langer, Chem. Tech. 12:98, 1982), ethylene vinyl acetate (Langer et al., Id), or poly-D-(−)-3-hydroxybutyric acid (EP 133,988A). Sustained release compositions also include liposomally entrapped compounds, which can be prepared by methods known per se (Epstein et al., Proc. Natl. Acad. Sci. U.S.A. 82:3688, 1985; Hwang et al., Proc. Natl. Acad. Sci. U.S.A. 77:4030, 1980; U.S. Pat. Nos. 4,485,045 and 4,544,545; and EP 102,324A). Ordinarily, the liposomes are of the small (about 200-800 Angstroms) unilamelar type in which the lipid content is greater than about 30 mol % cholesterol, the selected proportion being adjusted for the optimal therapy. Such materials can comprise an implant, for example, for sustained release of the presently disclosed compounds, which, in some embodiments, can be implanted at a particular, pre-determined target site.

Pharmaceutical compositions for parenteral administration include aqueous solutions of active compounds. For injection, the presently disclosed pharmaceutical compositions can be formulated in aqueous solutions, for example, in some embodiments, in physiologically compatible buffers, such as Hank's solution, Ringer' solution, or physiologically buffered saline. Aqueous injection suspensions can contain substances that increase the viscosity of the suspension, such as sodium carboxymethyl cellulose, sorbitol, or dextran. Additionally, suspensions of the active compounds or vehicles include fatty oils, such as sesame oil, or synthetic fatty acid esters, such as ethyl oleate or triglycerides, or liposomes. Optionally, the suspension also can contain suitable stabilizers or agents that increase the solubility of the compounds to allow for the preparation of highly concentrated solutions.

For nasal or transmucosal administration generally, penetrants appropriate to the particular barrier to be permeated are used in the formulation. Such penetrants are generally known in the art.

For inhalation delivery, agents for use within the methods of the presently disclosed subject matter also can be formulated by methods known to those of skill in the art, and may include, for example, but not limited to, examples of solubilizing, diluting, or dispersing substances such as, saline, preservatives, such as benzyl alcohol, absorption promoters, and fluorocarbons.

Additional ingredients can be added to compositions for topical administration, as long as such ingredients are pharmaceutically acceptable and not deleterious to the epithelial cells or their function. Further, such additional ingredients should not adversely affect the epithelial penetration efficiency of the composition, and should not cause deterioration in the stability of the composition. For example, fragrances, opacifiers, antioxidants, gelling agents, stabilizers, surfactants, emollients, coloring agents, preservatives, buffering agents, and the like can be present. The pH of the presently disclosed topical composition can be adjusted to a physiologically acceptable range of from about 6.0 to about 9.0 by adding buffering agents thereto such that the composition is physiologically compatible with a subject's skin.

Regardless of the route of administration selected, agents for use within the methods of the presently disclosed subject matter, which may be used in a suitable hydrated form, and/or the pharmaceutical compositions are formulated into pharmaceutically acceptable dosage forms such as described below or by other conventional methods known to those of skill in the art.

Kits Comprising Prenatal Dietary Supplements

The presently disclosed subject matter also relates to kits for practicing the methods of the presently disclosed subject matter. In general, a presently disclosed kit contains some or all of the components, reagents, supplies, and the like to practice a method according to the presently disclosed subject matter. In some embodiments, the term “kit” refers to any intended any article of manufacture (e.g., a package or a container) comprising at least one prenatal dietary supplement and a set of particular instructions for practicing the methods of the presently disclosed subject matter. The kit can be packaged in a divided or undivided container, such as a carton, bottle, ampule, tube, etc. The presently disclosed supplements can be packaged in dried, lyophilized, or liquid form. In some embodiments, the supplements are packaged in pill, capsule, or tablet form.

In some embodiments, the presently disclosed subject matter provides a kit comprising: (a) a prenatal dietary supplement described herein; and (b) a package insert or label with directions to administer the prenatal dietary supplement to a pregnant woman during the second and/or third trimesters of her pregnancy.

In some embodiments, the directions instruct the pregnant woman to take the prenatal dietary supplement on an empty stomach or after drinking a liquid, such as water. In some embodiments, the directions instruct the pregnant woman to take the prenatal dietary supplement at night.

Methods for Using a Prenatal Dietary Supplement

In some embodiments, the presently disclosed methods change the natural microbiome of a pregnant woman, the method comprising administering a prenatal dietary supplement of presently disclosed subject matter to the pregnant woman. In some embodiments, by changing the natural microbiome of a pregnant woman, the presently disclosed methods protect the pregnant woman and her fetus against transient bacteremia and/or ascending infection. In some embodiments, by protecting the pregnant woman and her fetus against transient bacteremia and/or ascending infection, the presently disclosed methods increase the length of gestation of a fetus. The prenatal dietary supplement disclosed herein may increase the length of gestation of a fetus in a pregnant woman by at least 5%, at least 10%, at least 15%, at least 20%, or at least 25% compared to the length of gestation of the fetus in the pregnant woman in the absence of supplementation with the supplement. In some embodiments, the natural microbiome comprises a microbiome of the oral cavity, genital tract, and/or gastrointestinal tract of the pregnant woman.

In some embodiments, the methods comprise selecting a pregnant woman whose fetus is thought to need an extended length of gestation. The selection of a pregnant woman may be based on a variety of factors, such as a family history of relatives giving birth to a premature baby or giving birth to a baby before the due date even though it may be mature, and/or the pregnant woman herself giving birth previously to a baby born prematurely or born before the baby's due date. In some embodiments, the length of the gestation is expected to be increased by at least about 1 day, 2 days, 3 days, 4 days, 5 days, 6 days, a week, two weeks, three weeks, a month, two months or more.

It is believed that the fluoride in the prenatal dietary supplement described herein aids in changing the natural microbiome of a pregnant woman. Thus, in some embodiments, the prenatal dietary supplement does not comprise compounds that reduce the bioavailability of fluoride. In addition, in some embodiments, the supplement is administered in the absence of other sources of compounds that reduce the bioavailability of fluoride, such as calcium.

Therefore, in some embodiments, the prenatal dietary supplement is administered when the pregnant woman has an empty stomach. In some embodiments, the prenatal dietary supplement is administered when the pregnant woman has previously ingested a liquid, such as water. In some embodiments, the prenatal dietary supplement is administered with plenty of water. In some embodiments, plenty of water comprises consuming at least 8 OZ, at least 16 OZ, at least 24 OZ, at least 32 OZ, at least 48 OZ, or at least 64 OZ between about 120 minutes, 90 minutes, 60 minutes, 45 minutes, 30 minutes, or 15 minutes before and after taking the prenatal dietary supplement. In some embodiments, the supplement is formulated for administration after the pregnant woman drinks up to about 4 cups of water prior to taking the supplement. In some embodiments, the pregnant woman is administered the supplement along with about 0.5 cups (4 ounces) of water. In some embodiments, the pregnant woman is administered the supplement at least 3 or at least 4 hours before the pregnant woman consumes a food, beverage, or other supplement comprising calcium. In some embodiments, the pregnant woman is administered the supplement at least 1 hour after the pregnant woman consumes a food, beverage, or other supplement comprising calcium. In some embodiments, the prenatal dietary supplement is administered at least approximately 6 hours before or after the pregnant woman consumes a food, beverage, or other supplement comprising calcium. In some embodiments, the pregnant woman is instructed not to drink milk or consume any other food, beverage, or other supplement comprising calcium at least 3 or at least 4 hours before taking, or at least 1 hour after taking, the prenatal dietary supplement.

In some embodiments, the prenatal dietary supplement is administered at night when other sources of calcium are not taken. In some embodiments, the prenatal dietary supplement is administered once every 24 hours. In some embodiments, the prenatal dietary supplement is administered during the second and/or third trimester of pregnancy. In some embodiments, the prenatal dietary supplement is administered (e.g., once daily at nighttime on an empty stomach with plenty of water) from the 12th week of pregnancy until the pregnant woman gives birth.

In some embodiments, the prenatal dietary supplement is administered once every 24 hours at nighttime with plenty of water when other sources of calcium are not taken.

The subject treated by the presently disclosed methods in their many embodiments is desirably a human pregnant woman, although it is to be understood that the methods described herein are effective with respect to all female vertebrate species, which are intended to be included in the term “subject.” Accordingly, a “subject” can include a female human subject for medical purposes, such as for the treatment of an existing disease, disorder, condition or the prophylactic treatment for preventing the onset of a disease, disorder, or condition or a female animal subject for medical, veterinary purposes, or developmental purposes. Suitable animal subjects include mammals including, but not limited to, primates, e.g., humans, monkeys, apes, gibbons, chimpanzees, orangutans, macaques and the like; bovines, e.g., cattle, oxen, and the like; ovines, e.g., sheep and the like; caprines, e.g., goats and the like; porcines, e.g., pigs, hogs, and the like; equines, e.g., horses, donkeys, zebras, and the like; felines, including wild and domestic cats; canines, including dogs; lagomorphs, including rabbits, hares, and the like; and rodents, including mice, rats, guinea pigs, and the like. An animal may be a transgenic animal.

### General Definitions

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The following Examples are offered by way of illustration and not by way of limitation.

### Example 1

### Exemplary Ranges of Amounts of Compounds in a Prenatal Dietary Supplement

In this Example, some exemplary ranges of amounts of compounds in an embodiment of a presently disclosed dietary supplement are shown in Table 1.

TABLE 1
Ranges of amounts of compounds

| Compound | Range |
|---|---|
| Source of fluoride | 6-11 mg |
| Vitamin C | 0-2000 mg |
| Vitamin B₁ | 0-100 mg |
| Vitamin B₂ | 0-60 mg |
| Vitamin B₃ | 0-35 mg |
| Vitamin B₅ | 0-100 |
| Vitamin B₆ | 0-50 mg |
| Vitamin B₁₂ | 0-150 μg |
| Folic acid | 0-1 mg |
| Magnesium sulfate | 0-69 mg |
| Zinc | 0-40 mg |
| Copper | 0-10 mg |
| Manganese sulfate | 0-13 mg |

### Example 2

### Exemplary Embodiment of a Prenatal Dietary Supplement

In this Example, some exemplary amounts of compounds in an embodiment of a presently disclosed dietary supplement are shown in Table 2.

TABLE 2
Amounts of compounds in an exemplary embodiment

| Compound | Amount |
|---|---|
| Source of fluoride | 6.6 mg |
| Vitamin C | 200 mg |
| Vitamin B₁ | 10 mg |
| Vitamin B₂ | 6 mg |
| Vitamin B₃ | 30 mg |
| Vitamin B₅ | 10 mg |
| Vitamin B₆ | 5 mg |
| Vitamin B₁₂ | 15 μg |
| Folic acid | 1 mg |
| Magnesium sulfate | 6.9 mg |
| Zinc | 18.2 mg |
| Copper | 0.8 mg |
| Manganese sulfate | 1.3 mg |

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

1-2. (canceled)

3: A prenatal dietary supplement comprising a source of fluoride in an amount effective to provide in the range of about 6 mg and 11 mg of bioavailable fluoride.

4: The prenatal dietary supplement of claim 3, wherein the amount effective comprises about 6.6 mg of the source of fluoride.

5: The prenatal dietary supplement of claim 3, wherein the supplement comprises decreased amounts of at least one cation that complexes with fluoride to reduce bioavailability of fluoride.

6: The prenatal dietary supplement of claim 5, wherein the at least one cation is selected from the group consisting of calcium and magnesium.

7: The prenatal dietary supplement of claim 3, wherein the supplement comprises a source of calcium that does not complex with fluoride to reduce the bioavailability of fluoride.

8: The prenatal dietary supplement of claim 7, wherein the source of calcium comprises calcium complexed to a vitamin.

9: The prenatal dietary supplement of claim 8, wherein the source of calcium comprises calcium complexed to vitamin B₅.

10: The prenatal dietary supplement of claim 9, wherein the supplement comprises about 10 mg of vitamin B₅ and about 0.84 mg calcium as a complex.

11: The prenatal dietary supplement of claim 3, wherein the source of fluoride is selected from the group consisting of sodium fluoride, sodium monofluorophosphate, stannous fluoride, and combinations thereof.

12: The prenatal dietary supplement of claim 3, wherein the source of fluoride comprises sodium fluoride.

13: The prenatal dietary supplement of claim 3, further comprising between about 0 mg and about 2000 mg of vitamin C.

14. (canceled)

15: The prenatal dietary supplement of claim 3, further comprising between about 0 mg and 100 mg of vitamin B₁.

16. (canceled)

17: The prenatal dietary supplement of claim 3, further comprising between about 0 mg and 60 mg of vitamin B₂.

18. (canceled)

19: The prenatal dietary supplement of claim 3, further comprising between about 0 mg and 35 mg of vitamin B₃.

20. (canceled)

21: The prenatal dietary supplement of claim 3, further comprising between about 0 mg and 50 mg of vitamin B₆.

22. (canceled)

23: The prenatal dietary supplement of claim 3, further comprising between about 0 mg and 1 mg of folic acid.

24. (canceled)

25: The prenatal dietary supplement of claim 3, further comprising between about 0 μg and 150 μg of vitamin B₁₂.

26. (canceled)

27. The prenatal dietary supplement of claim 3, further comprising between about 0 mg and 100 mg of vitamin B₅.

28. (canceled)

29. The prenatal dietary supplement of claim 3, further comprising between about 0 mg and 69 mg of magnesium sulfate.

30. (canceled)

31. The prenatal dietary supplement of claim 3, further comprising between about 0 mg and 40 mg of zinc.

32-60. (canceled)
